(19) United States
(12) Patent Application Publication
(10) Pub. No.: US 2020/0262219 A1
(43) Pub. Date: Aug. 20, 2020

(54) WEB-FED INKJET DIGITAL PRINTING MACHINE

(71) Applicant: Bhavesh Maganbhai VACHHANI, Vadodara, Gujarat (IN)

(72) Inventor: Bhavesh Maganbhai VACHHANI, Vadodara, Gujarat (IN)

(21) Appl. No.: 16/647,918

(22) PCT Filed: Oct. 8, 2018
(86) PCT No.: PCT/IN2018/050636

§ 371 Date: Mar. 17, 2020

(30) Foreign Application Priority Data
Oct. 13, 2017 (IN) 201721036560

(51) Int. Cl. B41J 15/04; B41J 3/407; B41J 11/00; B41J 15/16

(52) U.S. Cl. CPC B41J 15/046; B41J 15/16; B41J 11/002; B41J 3/407

(57) ABSTRACT

A Web-Fed Inkjet Digital Printing Machine suitable for printing any kinds of Flexible substrates (materials), comprising of one or more printing stations wherein Web or Film path is brought vertically or angularly downwards at an angle between 10° to 175° from horizontal position or radially downwards at a radius of 5 millimeters to 4 meters after each colour or stage of printing. The Web or Film path can also be brought downwards first vertically or angularly and then radially or vice-versa, at angles between 10° to 175° and radius of 5 millimeters to 4 meters after each colour or stage of printing. The dryers are positioned on both or either sides and printheads are positioned along the Web or Film. An automatic control for guiding and tension control and pre-coater and post-coater for inline coating of the Web or Film is also available.

The following specification particularly describes the nature of this invention and the manner in which it is to be performed:

The present invention relates to Digital printing machine. Though the intention of wording of this invention does not limit to the utility meters but after due course of invention and further practice in the industry, there will be or may be further modification, alteration and varied application of the same machine which can be utilized in variety of industries.

### FIELD OF INVENTION

The present invention relates to printing industry, more particularly Digital printing machinery and system therefore.

### BACKGROUND OF PRIOR ART

Prior the WEB based printing of different substrates like PET/BOPP/LDPE/Paper Films and Aluminum Foils and different Laminates was done by Rotogravure, Flexo and Web offset Printing Presses/Systems. Presently the same process continues BUT in addition DIGITAL INKJET Printing Technology has emerged.

### DRAWBACKS OF PRIOR ART

The prior art includes the Rotogravure Printing Machine which has cumbersome process of making cylinders and rubber rollers for the Rotogravure Presses and Stereos and Plates and Anilox Rollers required for the FLEXO and WEB offset presses and make the Production changeovers extremely slow and uneasy.

The prior art also includes the Digital Inkjet Printing Machine which has an expensive printing process and it requires very specialized ink material.

### OBJECTS OF THE INVENTION

The main objective of the invention is Introduction of dryers after each Inkjet Digital Printing Bar both horizontally and/or vertically or angularly down and/or radially down for drying the printed web from both sides after each colour is printed or after each stage of printing, thus the drying is improved and the quality of printing is improved.

Another objective of the invention is the printing can be done without the help of super specialty Inkjet inks but with simple normal Inkjet inks both water based or solvent based can be used thus bringing down the printing cost drastically.

Another objective of the invention is WEB-FED Inkjet Digital Printing machine layout plan of the present invention provides for web path or film path being brought vertically or angularly and/or radially down and increased number of dryers installed along with on both or either sides of the Web or Film path and reduction of the overall length and volume of the machine due to vertically or angularly installed dryers and/or radially installed dryers, thereby reducing the volume and space occupied by the machine.

Another objective of the invention is There is total operator simplicity and versatility achieved due to this machine because here the printing variations/changes etc. can be effected with the help of the computer without the need to change any parts as in contrast to the Rotogravure printing machine, where many parts like Rotogravure cylinder, rubber pressure rolls, Doctor blades etc. need to be changed for each colour for any design changes or variations in the printing design/matters etc.

Over and above the fast changeovers in production, extreme versatility can be achieved with variable data printing by incorporating the Digital Inkjet Technology in the present day Printing Machine by suitably Modifying and Incorporating the Digital Inkjet Print heads in the version (the present invention) of a Digital Inkjet Printing System/Machine. Also the Environment can be saved by the use of Water based (Aqua based) Inks instead of High VOC Solvent based Inks used in the Rotogravure/Flexo Printing Presses. More over even if the Solvent based Inks are used in the Digital Inkjet Print heads then also the Environment damage is less because the Digital Inkjet technology has a close loop Ink Recirculation system, where as in contrast the Rotogravure and the Flexo Printing Presses employ the Open Ink Tank and Open Ink Tray System where the Solvent Evaporation rate is very high.

Other objective of the invention are:

A) To Bring down the cost.

B) To make machine easy to operate.

C) This new system will require less maintenance.

D) To reduce operation time.

### SUMMARY OF INVENTION

Web Path Design incorporated in this Digital Printing Machine where the WEB (substrate Film) Travels through the Web Fed Inkjet Digital Printing Machine and the Films (WEB/Substrate) starts from the Unwinding Roll from UNWINDER TURRET with Auto Splicer and the Web or Film moves onwards through the Unwinding and Tension Control Infeed Station where the Tension of the Film is controlled and passes through the Pre-coater, where the Pre-coat if necessary is applied and then the Film passes to the First Individual Printing Station (assembly or unit) and below the First Digital Inkjet Printing Bar to get the First Colour (Stage) Printed and then immediately passes Horizontally through the Small Dryer and then immediately the Film comes down Vertically or Angularly at an angle between 10° to 175° and/or Radially at a radius between 5 mm (millimeters) to 4 meters in to the Secondary Dryers where the Printed Web or Films get Dried from both the Sides after the Digital Inkjet Printing is done on the Web/Film.

For Digital Printers Nobody has taken the placement of dryers horizontally and vertically or angularly and/or radially down and also have taken the Web or Film path horizontal and then vertically or angularly or radially down after each colour or each stage is Digital Inkjet Printed. Here each stage printing means either one colour or two colours or more . . . N . . . No. of colours can be printed in that individual printing station as per the arrangement of the print heads is done.

The Dryers can be selected from group consisting of hot air type, thermic fluid type, steam heated or fluid heated type, electric heated type, infrared heated type or any mixture or combination from the group and the dryers can be positioned on both or either sides of the Web or Film coming in a downwards/downstream direction horizontally and/or vertically or angularly and/or radially, which enables the drying of Web or Film coming in a downwards/downstream direction thereby reducing the length and space of the machine and enables faster drying and thereby increasing the printing speeds.

This Web or Film can be of any Substrates (Material) of Plastic Films like Polyester (PET), PP (Polypropylene), BOPP, CPP, PE, LDPE and various other types of Plastic Mono or Multilayered Laminated or Coated Films and also Aluminium Foils, Paper, Paperboard, Coated Paper, Laminated Paper, Laminated Foils etc., All kinds of Textiles.

and then Film (WEB) passes over the cross setting (cross registration) device and under the Photo Sensor System and there after the Dried and Printed Film passes through in between two pulling rollers which can be of any suitable material of Rubber or Metal and either Roller can be of Rubber or Metal. The upper pulling roller is connected with the Ball Screw for side registration which takes care of the side registration control of the printing with the feedback from Photo Sensor System. Then after the Film passes over the Linear Registration Assembly Roller where the Auto Linear Registration System takes care of the Linear Printing Registration with the feedback from the Photo Sensor System before the Film or Web goes further passing over the Individual Inspection Lights where the operator can view/inspect the printing after the first printing stage. There after the Web or Film passes over a Chilling Roll where the Film gets Cooled down and thereafter the Web or Film passes onwards to the Second Printing station and under the Second Colour or Stage Digital Inkjet Printing Bar and this process is repeated onwards for the number of colours or stages to be printed of the present Invention/WEB-FED Inkjet Digital Printing Machine which can also be equipped with Pre and Post Coater.

### BEST MODES FOR CARRYING OUT THE INVENTION

### Brief Description of the Drawings

In the Drawings:

FIG. 1 is the Layout of the Digital Printing System according to the present Invention Web-Fed Digital Inkjet Printing Machine (Press) with the Web or Film path being brought VERTICALLY DOWN after each colour or stage of printing, But with the dotted outlines showing the Individual Printing Station (35) the Pre-coater (37) and the Post-coater (38).

FIG. 2 is the Layout of the Digital Printing System according to the present Invention Web-Fed Digital Inkjet Printing Machine (Press) with the Web or Film path being brought RADIALLY DOWN after each colour or stage of printing, But with the dotted outlines showing the Individual Printing Station (35) the Pre-coater (37) and the Post-coater (38).

FIG. 3 is an enlarged view illustrating a state of the Digital Printing System more particularly the individual printing station in which the Web or Film is brought VERTICALLY DOWN for the better drying of the printed Web or Film.

FIG. 4 is an enlarged view illustrating a state of the Digital Printing System more particularly the individual printing station in which the Web or Film is brought RADIALLY DOWN for the better drying of the printed Web or Film.

Mentioned below is the numbering of parts in the diagrams:

(01) UNWINDER TURRET WITH AUTO SPLICER

(02) SAFETY-CHUCK/AIR SHAFT

(03) ULTRASONIC EDGE-GUIDE SENSOR

(04) IN-FEED DANCER ROLLER

(05) UNWINDER LOAD CELL

(06) IN-FEED STATION (ASSEMBLY/UNIT)

(07) IN-FEED LOAD CELL

(08) PNEUMATIC PRESSURE RUBBER ROLL

(09) NIP ROLLER FOR IN-FEED WITH SERVO MOTOR

(10) MAIN DRIVE WITH SERVO MOTOR

(11) INDIVIDUAL FOUNDATION BASE

(12) BALL SCREW FOR SIDE REGISTRATION

(13) LINEAR PRESSURE ROLL ASSEMBLY

(14) DRYER

(15) DRYER

(16) DRYER

(17) INDIVIDUAL INSPECTION

(18) LINEAR REGISTRATION ASSEMBLY

(19) CROSS REGISTRATION SETTING DEVICE

(20) SLIDING COVER HOOD

(21) GEAR BOX (FOR EACH INDIVIDUAL PRINTING STATION)

(22) OUT-FEED DANCER ROLLER

(23) NIP ROLLER FOR OUT-FEED WITH SERVO MOTOR

(24) PNEUMATIC PRESSURE RUBBER ROLL

(25) WEB VIDEO INSPECTION SYSTEM

(26) OUT-FEED LOAD CELL ROLLER

(27) FINAL INSPECTION

(28) REWIND LOAD CELL ROLLER

(29) PNEUMATIC LAY-ON ROLL

(30) FINISH ROLL WINDER TURRET WITH AUTO SLICER

(31) CHILLING ROLL

(32) EXTRA DRYER

(33) DIGITAL INKJET PRINTING BAR WITH INKJET PRINTING HEADS

(34) INKJET PRINTHEAD AUTO CLEANING SYSTEM

(35) INDIVIDUAL PRINTING STATION

(36) INDIVIDUAL INK TANK WITH INK PUMP AND INK FILTERS

(37) PRE-COATER

(38) POST-COATER

(39) TURN BAR

(40) WEB/FILM

(41) PHOTO SENSOR SYSTEM

(42) OUTFEED STATION (ASSEMBLY/UNIT)

### DETAILED DESCRIPTION OF THE DIAGRAMS

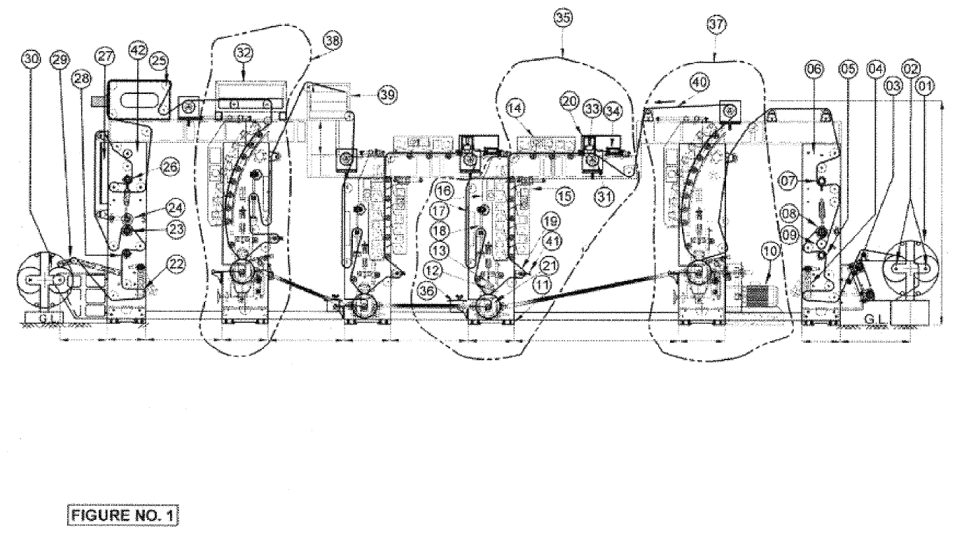

The WEB-FED INKJET DIGITAL PRINTING MACHINE is described here in detail along with the references to the Drawing FIG. 1 enclosed of the WEB-FED Inkjet Digital Printing Machine with Pre and Post Coater. Here in FIG. 1 the Web or Film Path is shown being brought vertically down after each colour or stage of printing.

Starting from the Unwinder Turret with Auto Splicer (01) the WEB (Film/Substrate) (40) which is there in the Roll Form, Web Roll is mounted on the Unwinder Turret with Auto Splicer with the Help of the Safety Chuck/Air Shaft as shown in Drawing (01), The WEB (Film/Substrate) (40) Unwinds and Passes between the Ultrasonic Edge Guide Sensor (03) which keeps the WEB or FILM (40) Unwinding in a straight line throughout the Printing process. Thereafter the WEB or FILM (40) goes in to the Infeed Station (06) where the Infeed Dancer Roller (04), the Unwinder Load cell (05), the Infeed Load cell (07), Pneumatic Pressure Rubber Roll (08) and Nip Roller Infeed with Servo Motor/Motor (09) keeps the Web or Film in proper Tension Control to achieve the Stable Web/Film Tension and Stable Printing during the Printing process. After this the Web or Film passes through the Pre Coater (37) where the Web or Film gets a Pre-Coating if needed or as required.

Thereafter the Web/Film (40) enters the First individual Printing Station (35) and this Individual Printing Station (35) is mounted on the Individual Foundation base (11). The Web or Film (40) thereafter passes through the First Colour or Stage Digital Inkjet Printing Bar with Inkjet Print heads (33). The Inkjet Digital Printing Bar with Print heads (33) is supplied with Ink via a closed loop Ink supply system from the Ink Tank with the Ink Pump and Ink Filters (36) where the First Colour or Stage of Digital Inkjet Printing is done. There is also installed along with the Inkjet Printing Bar the Inkjet Print head Auto Cleaning System (34), which Cleans the Print heads automatically at regular defined time intervals or as and when the cleaning is required. The Digital Inkjet Printing Bar (33) and the Inkjet Print head Auto Cleaning system (34) are covered and enclosed with a Sliding/Retractable Hood (Cover) (20). After the Inkjet Printing the Web or Film (40) travels horizontally or radially for a short path below the Dryer (14) where the Drying of the Printed Web or Film (40) starts.

Thereafter to reduce the Length of the overall Machine the Web or Film path is so designed that the Web or Film (40) is immediately brought down (travels downstream) vertically or angularly or radially down passing through further Nos. of Dryers (15) (16) for the perfect drying of the Inkjet Printed Web or Film (40).

Here the Web or Film is shown being brought Vertically Downwards at an angle of 90° from the horizontal position but it can be brought vertically or angularly down at an angle between 10° to 175° from the horizontal position or radially downwards at a radius of 5 mm (millimeters) to 4 meters, OR, it can be a combination of vertically or angularly and/or radially down, OR, radially and/or vertically or angularly down after each colour or stage of printing.

The Dryers can be selected from group consisting of hot air type, thermic fluid type, steam heated or fluid heated type, electric heated type, infrared heated type or any mixture or combination from the group.

The dryers can be positioned on either sides of the Web or Film horizontally and/or vertically and/or radially, which enables the drying of Web or Film coming in a downwards/downstream direction thereby reducing the length and space of the machine and enables faster drying and thereby increasing the printing speeds.

Thereafter the Dried Web or Film (40) travels over the Cross Registration Setting Device (19). Thereafter the Web/Film (40) travels through the Pulling Rollers of Linear Pressure Roll Assembly (13). The upper Pulling Rollers of the Linear Pressure Roll Assembly (13) is connected with Ball screw for Side Registration Control (12) of the Printing with the feedback from the Photo Sensor System (41). The Linear Pressure Roll Assembly (13) of each Individual Printing Stations (35) gets the Drive from the Gear Box (21) for each Individual Printing Stations. All the Input Shafts of Gear Boxes for each individual Printing Stations (35) are connected with the help of Shafts and Couplers and there is only ONE main Drive with Servo Motor/Motor (10), driving all the Printing Stations. So all the Individual Printing Stations whether it may be 1 Colour or Stage Printing Station, 2 Colour or Stage Printing Stations, 3, 4, . . . 8 Colour or Stage Printing Stations or N. No. of Printing Stations the Main Drive is through Motor/Servo Motor. The Unwinder and Infeed Station have a separate Drive Motor/Servo Motor and also the Outfeed Station and Film Roll Unwinder have a separate Motor/Servo Motor. After the Web or Film (40) exits the Linear Pressure Roll Assembly (13), it travels through over the Roller Controlling the Linear Registration Assembly (18), the Linear Registration Assembly (18) with the help of the feedback from the Photo Sensor System (41) automatically controls the Linear Registration of the Printing.

and after that the Web/Film (40) travels over the Individual Inspection System (17) which has special lights/View System installed to view the Printed Web or Film (40) after each Individual Colour or Stage of Printing for the Operator to Inspect the Printing. There after the Web or Film (40) travels over the Chilling Roll (31) where the Roll is Chilled by Chilled Water if required to Cool down the Temperature of Web or Film (40) before it enters the Second Colour or Stage Individual Printing Station (35). Here each colour or stage printing means that in that stage of individual printing station (35) the printing can be done with one, two or three or . . . N. No. of colours as per the arrangements of the Printheads in that individual printing station.

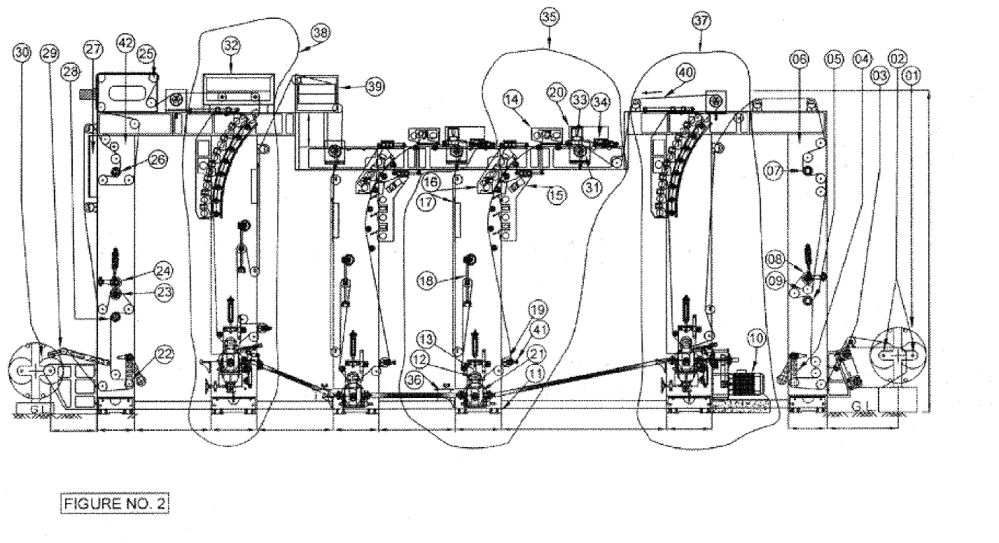

Now the same Printing Process as described above is repeated in the Second Individual Printing Station (35) (assembly or unit) and thereafter Third Individual Printing Station (assembly or unit) and so on. In the Drawing FIG. 1 and FIG. 2 we have shown 2 Individual Printing Stations which is only an example, however the WEB-FED Inkjet Digital Printing Machine can be from 1 Individual Printing Station (assembly or unit) (35), to 2, 3, 4, . . . 8, 9, 10, . . . N. Number of Individual Printing Stations as per the requirement of different colours or printing effects. Similarly the Width shown in Drawing of the WEB-FED Inkjet Digital Printing Machine/Press is for example only and the Width of the WEB-FED Inkjet Digital Printing Machine/Press can vary as per the different requirements of WEB or FILM Width starting from 100 mm (0.10 meter) Width to up to 5000 mm (5 meter) of Web or Film Width.

After the Web or Film (40) has travelled through All the Individual Printing Stations (35), the Web/Film (40) passes through the TURN BAR (39) where if required the Web or Film (40) Position can be reversed before it enters the Post Coater (38). This way the Final Printed Web/Film (40) can be given a Post coating of any colour or coating or functional coating on any of the side of the Web/Film (40) i.e. Printed side or the Non Printed side of the Web or Film (40) with the help of the TURN BAR (39).

After the Web or Film (40) has travelled through all the Individual Colour Printing Stations and the Post Coater (38) the Web/Film (40) enters the Extra Dryer (32) where Extra Drying takes place to remove any excess Moisture/Residual Solvents from the Printed/Coated Web or Film (40).

Thereafter the Film enters the Section of the Web Video Inspection System (25) where the Fully Automatic Web Video Inspection System (25) is Installed to Inspect Online Continuous Inspection of the Printed Web/Film (40) and can be viewed on a Computer Monitor/TV Screen.

Thereafter the Web or Film (40) goes in to the Outfeed Station (42) and through over the Outfeed Load cell Roller (26) onwards to and over the Final Inspection (27) onwards through over the Nip Roller for Outfeed with Servo Motor/Motor (23) and Pneumatic Pressure Rubber Roll (24) onwards to the Rewind Load cell Roller (28) further onwards over the Outfeed Dancer Roller (22) where the Outfeed and Rewind Tension Control of the Web/Film (40) is controlled before the Final Printed Web or Film (40) goes and Rewinds in the Finish Roll Winder Turret with Auto Splicer (30) after passing through and over the Pneumatic Lay on Roll (29).

FIG. 2—Here the working description is the same as described in FIG. 1 description as above, except that in the FIG. 2 Drawing the Web or Film Path is shown being brought RADIALLY DOWN after each colour or stage of printing.

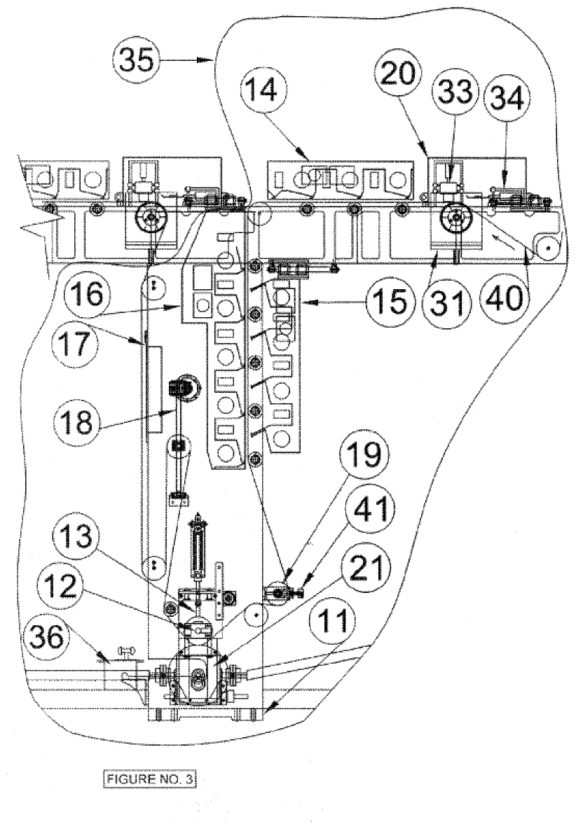

FIG. 3—Enlarged view drawing describes more in detail how the Web or Film (40) is brought vertically or angularly and/or radially down for the drying after the each colour or stage digital inkjet printing is done on the Web or Film (40) by the Digital Inkjet Printing bar with Inkjet Print Heads (33). Here in FIG. 3 particularly the Web or Film path is shown being brought VERTICALLY DOWN after the each colour or stage of printing.

The Web or Film (40) after it passes below the Digital Inkjet Printing Bar (33) where the Digital Inkjet Printing is applied and thereafter the Web or Film moves forward passing under the Dryer (14), here the Dryer shown is One number but it is not limited to one and can be two, three or many more . . . N. No. of Dryers installed as per the requirement and also if more drying not required these Dryers can be avoided totally to further decrease the overall length of the Machine.

Then the Web or Film (40) is brought vertically or angularly or radially down (travel downwards/downstream) for the further drying of the Inkjet Printed Web or Film (40) passing in between two sets of dryers (15) (16) shown here are one each vertically or radially installed on either side of the vertically or radially down (coming) passing printed Web/Film (40), But it is not limited to numbers and/or types of dryers, means it can be 1 or 2, 3 or 4 or more . . . N. No. of Dryers and can be hot air type, Thermic fluid heated type, Electric heated type etc. as per the needs and requirements.

This Web or Film can be of any Substrates (Material) of Plastic Films like Polyester (PET), PP (Polypropylene), BOPP, CPP, PE, LDPE and various other types of Plastic Mono or Multilayered Laminated or Coated Films and also Aluminium Foils, Paper, Paperboard, Coated Paper, Laminated Paper, Laminated Foils etc., All kinds of Textiles.

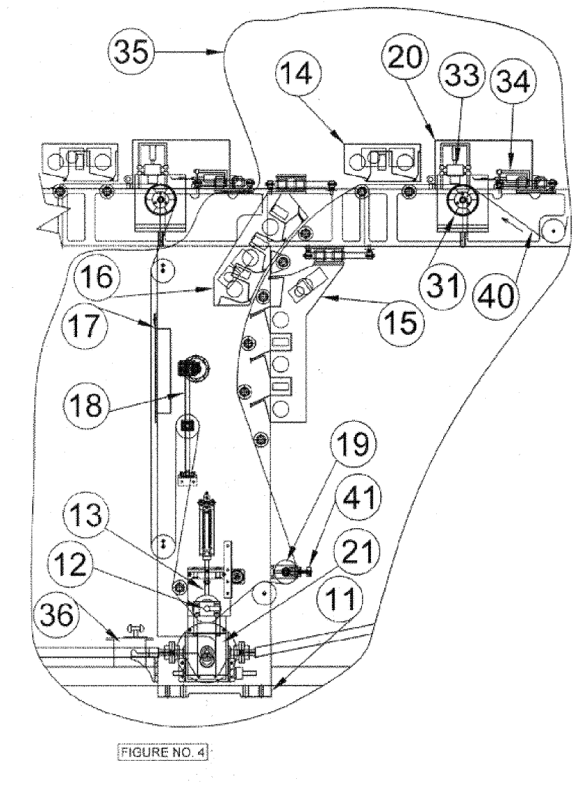

FIG. 4—Is an Enlarged view drawing and the working description is same as above shown in FIG. 3 except that here in FIG. 4 particularly the Web or Film path is shown being brought RADIALLY DOWN after the each colour or stage of printing.

I claims:

1. A Web-Fed Inkjet Digital Printing Machine comprising of one or more printing stations (35) wherein Web or Film (40) path is brought angularly downwards at an angle between 10° to 175⁰ from horizontal position or radially downward at a radius of 5 mm (millimeters) to 4 meters after each colour or stage of Inkjet Printing.

2. A Web-Fed Inkjet Digital Printing Machine according to claim 1 where in Web or Film (40) path can also be brought downwards first angularly and then radially or first radially and then angularly downwards, at the angles and radius mentioned in above claim 1 after each colour or stage of Inkjet Printing.

3. A Web-Fed Inkjet Digital Printing Machine according to claim 1 wherein the Dryers (14) (15) (16) are positioned on both or either sides of the Web or Film (40).

4. A Web-Fed Inkjet Digital Printing Machine according to claim 3 wherein the Quantity of Dryers (14) (15) (16) can be one or more Numbers and wherein the Dyers (14) (15) (16) can be selected from group consisting of hot air type, thermic fluid type, steam heated or fluid heated type, electric heated type, infrared heated type or any mixture or combination from the group.

5. A Web-Fed Inkjet Digital Printing Machine according to claim 1 wherein the Print bar with the Inkjet Printheads (33) is positioned along with Web or Film (40) to print one or more colours per stage or per printing station (35).

6. A Web-Fed Inkjet Digital Printing Machine according to claim 1 wherein the arrangements of rollers guiding the Web or Film (40) are installed at such angle or radius for the proper guiding and support of the Web or Film (40) being brought down after each colour or stage of printing.

7. A Web-Fed Inkjet Digital Printing Machine according to claim 1 wherein the Web or Film (40) being printed can be of any material (substrates) from Plastic Films like Polyester (PET), PP (Polypropylene), BOPP, CPP, PE, LDPE and various other types of Plastic Mono or Multilayered Laminated or Coated Films and also Aluminium Foils, Paper, Paperboard, Coated Paper, Laminated Paper, Laminated Foils, Coated Foils, Coated and Laminated Foils or Laminates made from any Substrates of Plastic, Aluminium Foil, Paper whether Coated or not, All kinds of Textiles.

8. A Web-Fed Inkjet Digital Printing Machine according to claim 1 wherein the Print registration is automatically controlled with cross registration setting device (19), the Linear pressure roll assembly (13), and the Ball screw for side registration (12), and the Linear registration assembly (18), with feedbacks from the Photo sensor system (41).

9. A Web-Fed Inkjet Digital Printing Machine according to claim 1 wherein there is individual inspection (17) facility for the manual inspection of the printed Web or Film (40) after each colour or stage of printing, for the operator to view or inspect and monitor the on going live printing after each colour or stage of printing in each individual printing station (35) assembly, thus able to monitor and manage each colour or stage of printing.

10. A Web-Fed Inkjet Digital Printing Machine according to claim 1 wherein the tension control and guiding of the unwinding Web or Film (40) throughout the printing is controlled in the infeed station (06) with the ultrasonic edge guide sensor (03), the infeed dancer roller (04), the unwinder load cell (05), the infeed load cell (07), pneumatic pressure rubber roll (08) and Nip roller infeed with Servo Motor/Motor (09).

11. A Web-Fed Inkjet Digital Printing Machine according to claim 1 wherein the outfeed and rewind tension control of the Web or Film (40) is controlled in the outfeed station (42) assembly with the outfeed load cell roller (26), the Nip roller for outfeed with Servo Motor/Motor (23), the pneumatic pressure rubber roll (24), the rewind load cell roller (28), the outfeed dancer roller (22) and the pneumatic lay on roll (29).

12. A Web-Fed Inkjet Digital Printing Machine according to claim 1 wherein pre-coater (37) and post-coater (38) are incorporated to give a pre coating and post coating to the Web or Film (40).

13. A process of printing Web or Film using Web-Fed Inkjet Digital Printing Machine (Press) comprising one or more printing stations (35), wherein said process comprises of bringing the Web or Film (40) path angularly downwards at an angle between 10° to 175° from horizontal position or radially downward at radius of 5 mm (millimeters) to 4 meters after each colour or stage of Inkjet Printing.

14. A process according to claim 13 wherein positioning of one or more Dryers (14) (15) (16) on both or either sides of the Web or Film (40) after each colour or stage of Inkjet Printing.

15. A process according to claim 14 wherein the Dryers are selected from group consisting of hot air type, thermic fluid type, steam heated or fluid heated type, electric heated type, infrared heated type or any mixture or combination from the group.

16. A process according to claim 13 wherein the Print bar with Inkjet Printheads (33) is positioned along with Web or Film (40) to print one or more colours per stage or per printing station (35).

17. A process according to claim 13 wherein the Web or Film (40) being printed can be of any material (substrates) from Plastic Films like Polyester (PET), PP (Polypropylene), BOPP, CPP, PE, LDPE and various other types of Plastic Mono or Multilayered Laminated or Coated Films and also Aluminium Foils, Paper, Paperboard, Coated Paper, Laminated Paper, Laminated Foils, Coated Foils, Coated and Laminated Foils or Laminates made from any Substrates of Plastic, Aluminium Foil, Paper whether Coated or not, All kinds of Textiles.

18. A process according to claim 13 wherein the process of print registration is automatically controlled with cross registration setting device (19), the Linear pressure roll assembly (13), and the Ball screw for side registration (12), and the Linear registration assembly (18), with feedbacks from the Photo sensor system (41).

19. A process according to claim 13 wherein there is individual inspection (17) facility for the manual inspection of the printed Web or Film (40) after each colour or stage of printing, for the operator to view or inspect and monitor the on going live printing after each colour or stage of printing in each individual printing station (35) assembly, thus able to monitor and manage each colour or stage of printing.

20. A process according to claim 13 wherein the process to control the tension and guiding of the unwinding Web or Film (40), throughout the printing process is controlled in the infeed station (06) with the ultrasonic edge guide sensor (03), the infeed dancer roller (04), the unwinder load cell (05), the infeed load cell (07), pneumatic pressure rubber roll (08) and Nip roller infeed with Servo Motor/Motor (09).

21. A process according to claim 13 wherein the process to control outfeed and rewind tension control of the Web or Film (40) is controlled in the outfeed station (42) assembly with the outfeed load cell roller (26), the Nip roller for outfeed with Servo Motor/Motor (23), the pneumatic pressure rubber roll (24), the rewind load cell roller (28), the outfeed dancer roller (22) and the pneumatic lay on roll (29).

22. A process according to claim 13 wherein there is process to give pre-coating and post-coating to the Web or Film (40) by the incorporation of the pre-coater (37) and post-coater (38).
